(19) United States
(12) Patent Application Publication
(10) Pub. No.: US 2002/0135176 A1
(43) Pub. Date: Sep. 26, 2002

(54) Method and system for printing and binding folded signatures

(76) Inventor: Helmut Domes, Stuttgart (DE)

Correspondence Address: Kevin L. Leffel, Heidelberg Digital L.L.C., 2600 Manitou Road, Rochester, NY, 14624, US

(21) Appl. No.: 10/080,355

(22) Filed: Feb. 21, 2002

(30) Foreign Application Priority Data
Feb. 22, 2001 (DE) 101 08 525.7

(51) Int. Cl. B42D 1/00

(52) U.S. Cl. 281/21.1

(57) ABSTRACT

The present invention relates to the binding of signatures and in one of its aspects relates to a method and apparatus for binding a digitally printed product such as “books on demand” wherein the signatures used in the printed product are produced by a digital printer or the like and the spine element used in binding products of different thicknesses can be supplied from a single supply roll.

### FIELD OF THE INVENTION

The present invention relates to the binding of folded signatures and in one of its aspects relates to a method and apparatus for printing and binding a printed product such as “books on demand” wherein the folded signatures used in the printed product are produced by a digital printer or the like and the spine element used in binding products of different thicknesses can be supplied from a single, “one size fits all” supply roll.

### BACKGROUND OF THE INVENTION

A magazine or a periodical is generally comprised of a stack of individual sheets, folded signatures, or sets of folded signatures that are bound or connected to one another in some way. If a stack of double wide sheets, printed on both sides, and folded once (called “folded signatures”) are properly collated and connected to one another, each folded signature represents four pages in the bound magazine or periodical. The arrangement of printed pages on a print format, which has a format that is at least twice as large as the printed page, is called “imposition” and is well known in the art, e.g. see H. Kipphan's “Handbuch der Printmedien” (Print Media Manual), Springer Verlag (2000)., page 553 et seq.

There are several known methods for binding signatures and/or stacks of signatures into books, periodicals, magazines, and the like. For a good detailed overview and discussion of several of these methods, see H. Kipphan's “Handbuch der Printmedien” (Print Media Manual), Springer Verlag (2000); page 861 et seq.

US patent U.S. Pat. No. 5,547,176 discloses one such method wherein four pages of a document is printed on a folded signature and is distributed in such a way that the pages corresponds exactly to the desired sequence of the pages of the document once the folded signature are properly stacked.

Another conventional method for binding magazines or periodicals involves merely stacking a number of collated signatures, one on top of another, folding the stack, and then stapling the stack together with a staple(s) or the like. In a typical magazine, a single set of folded signatures is stapled along the “center fold” (i.e. the innermost folded signature at the center point of such a magazine) of the stack. The center fold, itself, is unique as to the other signatures in the magazine since it provides the maximum continuous surface that can be printed and allows the magazine to lie substantially flat when it is opened to the center fold. Accordingly, it follows that if a magazine could be assembled to contain more than one “center fold”, the ease in printing and assembly, as well as the esthetic value, of the magazine could be substantially enhanced. While stapling is widely used in the binding of magazines, it is not well suited for conventional bookbinding since stapled signatures detract from the ease in reading the book. Also, staples may oxide and break and thereby present a danger of injury to the reader, and generally can have a poor, overall aesthetic effect on the binding of a book.

Still another binding method is disclosed in International patent application WO85/04669 that is typical of those used in producing magazines or paperback books. As disclosed, a polyurethane hot melt adhesive is applied on one edge of a stack of individual sheets and is allowed to cool/dry to bind the sheets together. However, the adhesive often requires a relatively long time to dry. Consequently the speed with which the magazines or periodicals can be produced is relatively slow thereby adversely affecting the economics of the operation. In addition, the adhesive may make the bonded edge of the sheets thicker than the rest of the document which, in turn, can be a disadvantage for commercial magazines and periodicals where aesthetics and form is important.

Further, hot melt adhesives can also be used for binding a stack of sets of folded signatures together where each set consists of two or more folded signatures. In a typical hot melt adhesive method of this type, the edge of each stack to be bound is cut such that the adhesive is applied to the edge of each individual sheet. Consequently, the advantage of having a centerfold in every set of folded signatures is lost since the completed product only contains individual sheets bound along only on one edge.

In other binding methods, printed signatures are also collated into sets of folded signatures before the sets are bound together by sealing wire or the like. In these methods, sealing clamps are inserted and joined in the last specified folding line. The set of folded sheets is then folded along the specified folding line. The sealing wire is captured, clamped, cut, and guided over the sealing line. The clamping action is effected by means of rotating pairs of forked needles that push the ends of the wire through the inside margin of the signatures. The securing of the detached wire stitch shanks is carried out with a sealing rail that is heated locally. The sets of folded signatures, once folded and bound, can then be glued onto a book back/cover or the like. Unfortunately, in these methods, the individual sets of folded signatures are connected to one another only by way of the adhesive bonding. Because of this, as with the standard hot melt adhesive, there is a danger that when the book is opened between two sets of folded signatures, the adhesive bond may tear or a set of folded signatures will loosen completely thereby ruining the integrity of the book.

A further binding method is disclosed in International patent application WO99/38707 wherein the adhesive material, heated by ultrasound, is unwound from a supply roller and is cut to size according to the thickness of the signature stack. In this method, the entire cover of the book is fed from a single piece of material, which is then folded and cut to size after it has been positioned onto and secured to the signature stack.

International patent application WO98/12056 discloses still another binding method wherein two or more folded signatures are put together to form a stack having a desired alignment. An activator, when applied to the edge of the stack, dissolves and mixes with a adhesive component which is present in the folded signatures thereby causing the edges of the folded signatures to bond together. The bonded edge is then allowed to dry to complete the operation.

Often, the need arises for producing personalized books or books with very small print runs, and in some extreme cases a print run of only one copy is needed, this being known as a “book-on-demand”. One device for producing such books is disclosed in U.S. Pat. No. 5,465,213 and this is also addressed in H. Kipphan's “Handbuch der Printmedien” [Print Media Manual], Springer Verlag (2000), page 989 et seq. For these small print runs to be commercially feasible, reliable, and cost-effective binding methods need to be available for assembling such books.

In view of the above, it can be seen that there is a continuing need for binding methods which are not only cost-effective and reliable but also for ones which produce an aesthetic binding of printed pages, especially where the pages are printed by a digital printing machine for “book(s) on demand”.

### SUMMARY OF THE INVENTION

The present invention concerns methods and apparatus for printing and binding a printed product. The invention is especially useful in printing and binding products produced in small numbers, e.g. “on demand” books. According to one aspect of the invention, a single-sized binding element may be used to bind products of different sizes and thicknesses. This reduces the need for large inventories and hence, reduces the overall costs of the operation.

According to one further aspect of the invention, a method and system for printing and binding a printed product are provided wherein the pages of the product are printed (i.e. preferably digitally printed by electrography, ink jet, or other digital printing process) on folded signatures in accordance with an imposition program which, in turn, is derived from a master and which is stored in a control unit for the printed pages on folded signatures for a document to be printed. As will be recognized in the art, the size of a folded signature corresponds to twice the size of a printed page so that four-printed pages are printed on the front and back of a folded signature. Being able to print and bind even other formats that are not used in typical printing methods lies within the scope of the inventive concept, in that these formats can be cut to size from folded signatures with larger formats, e.g. using a suitable cutting device. After printing, the folded signatures are collated according to the imposition program and are folded into sets by using a suitable folding mechanism, e.g. a knife folding apparatus.

After or during the printing and folding of the folded signatures, a length of the spine element is cut from a continuous roll of spine element. The spine element has an initial width which is adequate for binding any printed products having a thickness within an expected range. The cut length will essentially correspond to the size (e.g. height) of the folded signatures to be bound. Preferably, the spine element has a layer of adhesive thereon which is activated by the application of heat. A sheet of carrier element, e.g. gauze or other fabric, plastic film, paper, wire mesh, etc. is attached to the spine element at a point near its edge.

With the carrier element extend substantially perpendicularly outward from the spine, the sets of folded signatures are then fastened individually in succession to the carrier element through their respective center folds. The sets may be fastened to the carrier element by any appropriate means, e.g. stitching, saddle stitching with larger formats, wire stapling, sewing or other equivalent fastening methods, as known in the art. If sets of folded signatures which have only a few folded signatures are used, there is an advantage, especially in the case of wire stapling, that a very thin wire of the same length can be used for all thickness of the product to be bound. The requirements of the stapling head are thus very well defined. A higher stiffness of the inner book is also achieved by the profiling effect.

Where applicable, front and back covers may be properly positioned on the carrier element before and after the first and last sets of folded signatures, respective before the final binding takes place. As is typical in such binding operation, the front and/or back covers may consists of a material that is stiffer, e.g. cardboard, than that of the folded signatures. Further, the front and/or back covers can be preprinted before binding. In most cases, the individual fastening of the center fold of each set to the carrier element permits better handling of the bound printed product. Because of the hinge effect of the binding element, the cover is easier to open, especially when compared to products that are bound only with glue, since the back of the book does not have to be curled or grooved, as is typically with the soft cover of paperback products.

Once all of the folded signature sets are fastened to the carrier element and the front and/or back covers are in place, both the spine element and the carrier element can then be cut to their final if the original width proves to be too wide. The binding element is then bent around the stack of folded signature sets and the cover and the adhesive between spine element and carrier element of the binding element is activated, e.g. by application of pressure and heat. Great strength is achieved, because of the connection of the surface of the binding element with the outsides of the covers. In addition, the cover format does not depend on the book thickness, since the thickness adjustment is made using the binding element alone.

Due to the flexibility of the carrier element, the present invention according to a preferred embodiment makes it possible to open the finished, bound product so that it lays flat. Because of the use of relatively few folded signatures in each folded signature set, an acceptable appearance of the front edge of the bound product can be achieved without requiring another cost-intensive, page-cutting step for the finished product.

The apparatus and method suggested according to the invention for binding printed products can be used in all digital printing machines. Moreover, the present method can also be used extensively in all sheet-processing machines and their components that are equipped with a collating device, in order to collate the sets of folded signatures according to most, if not all, imposition programs. In addition, an application spectrum is opened up for all printing machines in which a large number of folded signatures will be combined with a spine to make a printed product. Also, manual supply of folded signature sets that are already connected may be possible.

### BRIEF DESCRIPTION OF THE DRAWINGS

The actual construction, operation, and the apparent advantages of the present invention will be better understood by referring to the drawings, not necessarily to scale, in which like numerals identify like parts and in which:

FIG. 1 is a perspective end view of the spine of the binding element in the initial step of the present binding operation having the carrier element attached thereto;

FIG. 2 is a side perspective view of FIG. 1;

FIG. 3 is schematic top view of an apparatus used in carrying out the present invention;

FIG. 4 is perspective end view of the spine and carrier element of FIG. 1 with a cover and sets of folded signatures being attached to said carrier element;

FIG. 5 is a perspective end view, similar to FIG. 4 with said spine and carrier being cut to length; and

FIG. 6 is a perspective end view, similar to FIG. 5 as the bound article appears in its final bound condition.

While the invention will be described in connection with its preferred embodiments, it will be understood that this invention is not limited thereto. On the contrary, the invention is intended to cover all alternatives, modifications, and equivalents which may be included within the spirit and scope of the invention, as defined by the appended claims.

### DESCRIPTION OF THE PREFERRED EMBODIMENTS

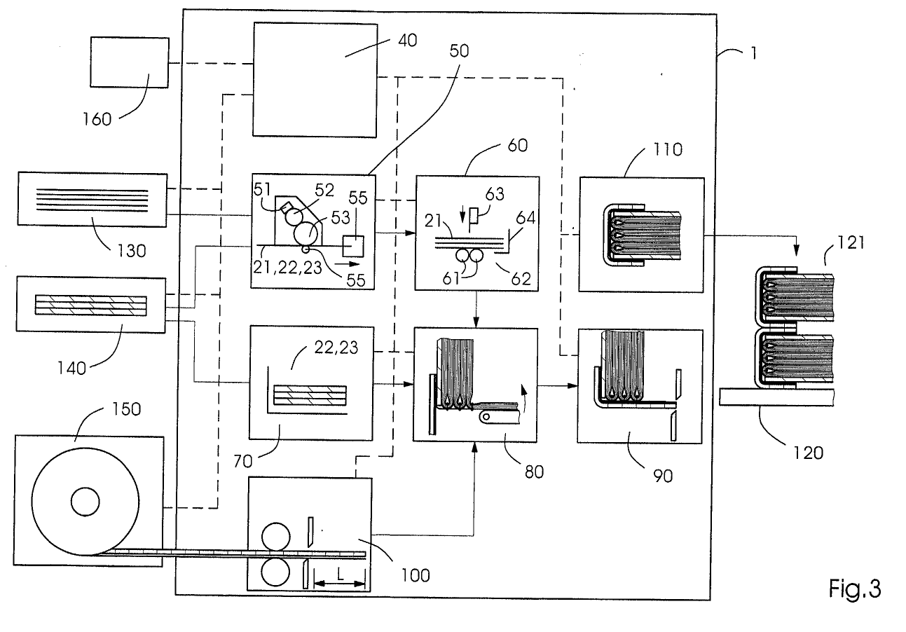

Referring now to the drawings, FIG. 3 discloses a printing and binding apparatus or system 1 which prints and binds a printed product (e.g. book, manual, magazine, etc.) in accordance with the present invention. While apparatus 1 can be used to print and bind different types of printed products, it is particularly useful in binding pages of a small print run (i.e. “book(s) on demand”) wherein the pages are printed by a digital printer. Prior to printing, a control unit 40 determines the desired imposition program, using an original or other available copy of the product as a “master”. In this process, the product to be printed is present in digital form, in a text format, or as image files, which can read into storage within control unit 40 by means of a scanner (not shown) or like devices. Based on these files, control unit 40 first determines the number of pages in the particular product to be printed and, based on this and other specifications (e.g. surface weight of the paper, thickness etc.) determines the number of folded signature sets 20 that will be needed for printing the product and the maximum thickness thereof. The the number of digitally printed signatures in each set may be determined according to a thickness of a media used to make the sets of folded signatures. Properties or indicia indicative of thickness may be implemented.

If necessary, other parameters, like the number of the folded signatures 21 in each of folded signature sets 20, the uniformity of distribution of the sets 20, and/or the distribution of two-page graphics on each of the centerfolds may be considered. These parameters may be determined by using sensors (not shown) or can be input and stored into memory by a user using an input device 160. The position of a particular printed page on a respective folded signature is determined by the number of folded signatures 21 that is to make up an individual folded signature set 20. Two-page spreads in a printed product may be determined, and multiple two-page spreads may be placed one each at a corresponding set of folded digitally printed signatures to take advantage of a folded signature at the center of the folded stack being fully in view when the stack is opened, for example when the printed product is finished and being perused.

While any particular imposition program will vary depending on the product being printed,. the following example is good representation of a typical imposition scheme; i.e. one which might be used to print a 60-page document in A4 paper format. The control unit 40 determines that printing the document will require the use of three (3) folded signature sets 20, each set being comprised of five (5) folded signatures 21, each of which, in turn, have four (4) pages of the product printed thereon in A3 format. The printing will then be carried out in accordance with the following sequence wherein: VS=front side of a folded signature 21, RS=back side of the same folded signature 21, l=left side of the same folded signature 21, and r=right side of the same folded signature 21:

### Print Sequence

1. (First A3 Sheet): VS l: Page 2 VS r: Page 19, RS l: Page 20, RS r: Page 1

2. (Second A3 Sheet): VS l: Page 4 VS r: Page 17, RS l: Page 18, RS r: Page 3

3. (Third A3 Sheet): VS l: Page 6 VS r: Page 15, RS l: Page 16, RS r: Page 5

4. (Fourth A3 Sheet): VS l: Page 8 VS r: Page 13, RS l: Page 14, RS r: Page 7

5. (Fifth A3 Sheet): VS l: Page 10 VS r: Page 11, RS l: Page 12, RS r: Page 9

Referring again to FIG. 3, a stack of blank folded signatures 21 are stored in a signature reservoir 130 from which they are transferred, on demand, one at a time to printer 59 (e.g. digital printer), which, in turn, prints four pages onto a folded signature in accordance with a predetermined, stored imposition program such as that set forth above. As will be recognized in the art, in this type of printer, the print information is typically transferred to by means of an imaging unit 51 to an image generating element 52 that holds a printing medium, e.g. a particular toner, ink, etc. The printing medium is then transferred onto transfer roller 53 and then onto a folded signature as it passes between transfer roller 53 and a pressure roller 54. The image (i.e. print medium) is then fixed on the folded signature by means of a fixing device 55 (e.g. heater), as is well known in printers of this type. For printing on both sides, typically the folded signature is turned over and fed through the printer 50 again. In this process, a folded signature can also be run through several printers, especially in the case of color printing, as will be understood in the art.

Once printed, the folded signatures 21 are sent to the folding device 60 and preferably collated at an alignment device 62, which, in turn, includes a register (not shown). Once it is determined that the number of folded signatures 21 in a particular set 20 has been reached, the folded signatures 21 are folded into a folded signature set 20 by a folding device 60, e.g. a pair of folding rollers 61 and knife folding blade 63. The folded signature sets 20 are then ready to be assembled and bound into the finished printed product.

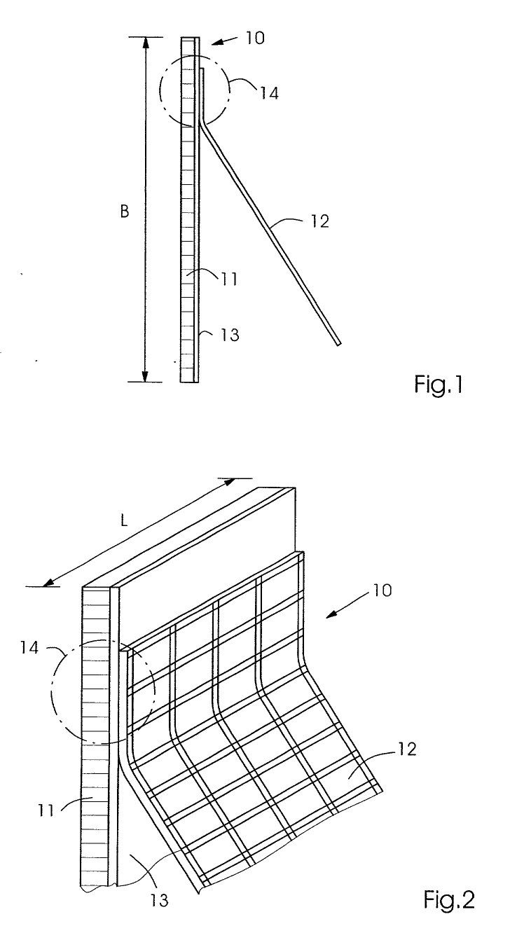

Referring now to FIGS. 1 and 2, a binding element 10 is illustrated which is comprised of a spine element 11 that, in turn, is preferably coated with an adhesive layer 13 (e.g. an adhesive which can be activated by heat). A continuous web or sheet of spine element 11 is preferably wound onto a supply roll in reservoir 150 (FIG. 3) and is unrolled as needed. As used herein, “length” L (FIG. 2) is used to refer to the height of the spine and essentially relates to the vertical length of the pages to be bound when the pages are standing on end. “Width” B (FIG. 1) is used to refer to the width of the spine element 11 which will be necessary to bind the final thickness of the printed product 121. Preferably, spine element 11 is of a width B which is large enough to bind the thickest printed product typically bound by binding system 1 and, if too wide for less thick products, can be trimmed later in the binding process as will be discussed below. By using a roll 150 of spine element 11 having a standard width B which can be cut to various lengths, a “one size fits all” roll of spine element 11 can be used for the binding of different sizes of printed products. This eliminates the need to stock several different sizes of spine element and thereby makes the binding method more attractive for use in small print runs (i.e. “on-demand” books, etc.).

Spine element 11 is reeled off its storage roll and is cut to length “L” by a first cutter in cutting mechanism (e.g. 100). Again, “L” is the dimension which will esthetically accommodate the height of the pages of the product to be bound. Preferably, the control unit 40 determines the length L of spine element 11 to be cut and is based on the stored specifications for the printed product 121 (FIG. 3) to be bound.

As best seen in FIGS. 1 and 2, the sheet of carrier element 12 is fastened onto spine element 11 at a designated attachment point 14. The size of carrier element essentially corresponds to the width and length of spine element 11 but vary slightly therefrom as will be understood in the art. Carrier element 12 is comprised of any of the durable and flexible materials commonly used in this art, e.g. gauze or other fabric, plastic film, paper, wire mesh, etc.

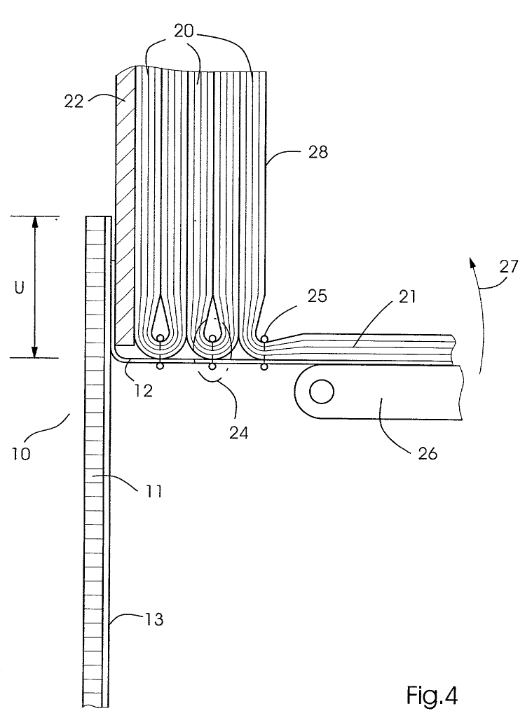

Binding element 10 is now transfer to assembly station 80 and is shown in FIG. 3 as being rotated 90° from the position shown at 100 in (FIG. 3). With carrier element 12 now extended at a substantial right angle with respect to spine element 11 (FIGS. 3-5), a first cover 22 is transported from cover reservoir 70, on demand, and is positioned onto carrier element 12 as shown in FIGS. 3-6. Cover 22 is positioned so that the binding element 10 will extend upward along the cover 22 for a prescribed height U (as viewed in FIGS. 4-6) which is adds both to strength and esthetic value of the finished printed product 121. It should be recognized that if the covers 22, 23 are to be printed that such printing is carried out (e.g. in printer 50) before the covers are collated in reservoir 70. Also, as known in this art, covers 22, 23 may be comprised of material (e.g. cardboard) which is stiffer than that of the folded signatures.

A first folded signature set 20, which has been collated, stacked, and folded in folder mechanism 60, is retrieved from folder mechanism 60 and is placed onto carrier element 12 next to cover 22, as shown in FIG. 4. The folded signature set 20 is then connected to carrier element 12 at a fastening point 24 in the center fold (i.e. centermost sheet) of the folded signature set 20 with any appropriate fastening means 25, e.g. stitching, saddle stitching, interweaving, gluing, a wire staple, etc.).

If the printed product requires more that one signature set 20, the subsequent sets of folded signatures 20 are then placed in collated succession and each is fastened onto the carrier element 12 as set forth above. Preferably, each signature set 20 is half open to its center fold when initially placed onto the carrier element 12 for ease in fastening. After a particular set 20 has been fastened to carrier element 12, it is then closed by the pivoted arm 26 which swings upward in the direction of the arrow 27 (as viewed in FIG. 4) so that the next folded signature set 20 can be positioned and fastened to carrier element 12.

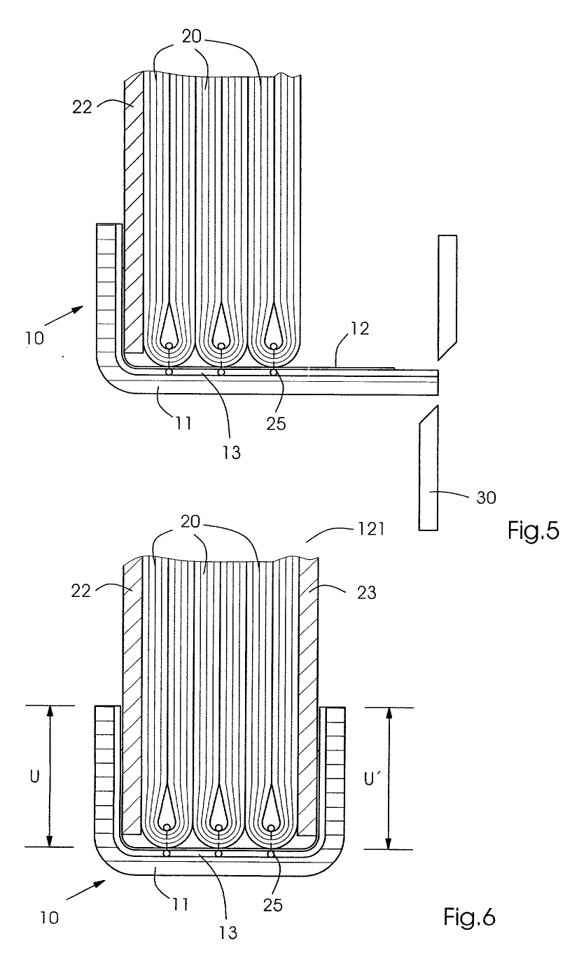

When all of the folded signatures sets 20 have been fastened onto the carrier element, a second cover element 23 is retrieved from cover reservoir 70 and is placed against the last of the signature sets 20. If the standard width B of the spine element 11 on supply roll 150 proves to be too wide, once the covers and sets of folded signatures have been assembled thereon, the binding element 10 is then trimmed to its final width by a second cutter 30 in a cutting device 90 (FIGS. 3 and 5). As seen in FIG. 6, preferably this final width is sufficient so as to allow the binding element 10, once wrapped around cover 23, to extend along the second cover 23 for a height U′ which, in turn, essentially corresponds to the height U on first cover 22 (FIG. 6). This adds strength to the binding and at the same time provides the bound product 121 with a good esthetic appearance.

To complete the binding operation, the printed product 121 is moved to gluing or finishing station (e.g. heater 110) where heat and pressure is applied to activate the adhesive 13 between carrier element 12 and spine element 11. The adhesive is the allowed to set and the finished printed product 121 then is ready for its intended use or is stored in a storage station 120.

The described control unit 40, printer 50, collating devices 64, 70, aligning devices 62, fixing devices 55, storage devices 120-140, and the various transport devices used to carry out the present invention are all known in the art and are routinely used in most digital printing machines. Folding devices 60 and cutting devices 30, 90, 100 are also known for processing printed products of this type; see H. Kipphan's “Handbuch der Printmedien” Springer Verlag (2000) [Print Media Manual] for examples of such available components.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

1. A printed product comprising a binding element having a spine element and a carrier element, and digitally printed signatures fastened to said binding element.

2. The product of claim 1, wherin said spine element 11 is coated with an adhesive.

3. The product of claim 1, wherein said carrier element 12 is paper.

4. The product of claim 1, wherein said carrier element is a plastic film.

5. The product of claim 1, wherein said carrier element is a wire mesh.

6. The printed product of claim 1, wherein said carrier element is fabric.

7. The printed product of claim 1, wherein said carrier element and said spine element are glued together.

8. The printed product of claim 1, wherein said carrier element and said spine element are woven together.

9. The printed product of claim 1, wherein said signatures are electrographically printed.

10. A method for producing a printed product from sets of folded signatures, comprising determining the number of digitally printed signatures in each set according to a thickness of a media used to make said sets of folded signatures.

11. A method for producing a printed product from sets of folded signatures, comprising determining two-page spreads, and deliberately placing multiple two-page spreads one each at a corresponding set of folded digitally printed signatures to take advantage of a center folded signature being fully in view.

12. A method for producing a printed product comprising fastening digitally printed signatures with a binding element having a spine element and a carrier element, and fastening said digitally printed signatures to said binding element.

13. The method of claim 12, further comprising digitally printing said signatures and immediately fastening them to said binding element.

14. The method of claim 12, further comprising tightly joining said digitally printed signatures to said binding element with a seam.

15. The method of claim 12, further comprising tightly joining said digitally printed signatures to said binding element with wire stitching.

16. The method of claim 12, further comprising tightly joining said digitally printed signatures to said binding element with wire stitching having a wire length that is essentially uniform for all thickness of the printed product.

17. The method of claim 12, further comprising folding said digitally printed signtures in sets.

18. The method of claim 12, further comprising determining the number of digitally printed signatures to be stapled together according to the weight of said digitally printed signatures.

19. The method of claim 12, further comprising considering a position of two-page spreads and arranging at least one at a center fold of a set of folded digitally printed signatures.

20. The method of claim 12, further comprising trimming a width of said binding element in accordance with a thickness of said digitally printed signatures.

21. The method of claim 12, further comprising printing cover elements and fastening them to said binding element.

22. The method of claim 12, further comprising cutting said binding element to length before fastening said digitally printed signatures to said binding element.

23. The method of claim 12, further comprising wrapping said binding element around an edge of said digitally printed signatures to be bound.

24. A product made by the method of claim 12.
